(19) United States
(12) Patent Application Publication
(10) Pub. No.: US 2004/0144575 A1
(43) Pub. Date: Jul. 29, 2004

(54) Digitizer pen for writing on reusable paper

(76) Inventors: Yitzhak Zloter, Holon (IL); Gideon Shenholz, Tel Aviv (IL)

Correspondence Address: DR. MARK FRIEDMAN LTD., C/O BILL POLKINGHORN, DISCOVERY DISPATCH, 9003 FLORIN WAY, UPPER MARLBORO, MD, 20772, US

(21) Appl. No.: 10/351,332

(22) Filed: Jan. 27, 2003

(51) Int. Cl. G09G 5/00

(52) U.S. Cl. 178/19.02

(57) ABSTRACT

A digitizer pen including a pen having an elongated body terminating in a tip, a locator device configured to enable tracking a location of the tip on a substrate and a writing implement primarily disposed within the elongated body. The writing implement has an electric charge substantially at the tip for writing on the substrate which is responsive to an applied electric field.

### FIELD AND BACKGROUND OF THE INVENTION

The present invention relates to a digitizer pen and, in particular, it concerns a digitizer pen configured for temporary writing.

By way of introduction, a digitizer system for tracking an electronic pen enables hand written documents and drawings to be tracked and stored electronically. The electronic pen communicates with a base unit of the digitizer system using a communications method that typically includes at least one of infrared signals, ultrasound signals and other communications method. The base unit also communicates with an external device such as a personal digital assistant (PDA) to record the movements of the electronic pen or stylus.

There is a short-term need to see the writing of the pen on the paper being used, as writing or drawing a picture is difficult if no visible impression is left of previous pen strokes. However, long term written record is made redundant. Long term written record is also a waste of resources, requires storage space and may compromise confidentiality.

There is therefore a need for a digitizer pen configured for temporary writing.

### SUMMARY OF THE INVENTION

The present invention is a digitizer pen.

According to the teachings of the present invention there is provided, a digitizer pen comprising a pen having: (a) an elongated body terminating in a tip; (b) a locator device configured to enable tracking a location of the tip on a substrate; and (c) a writing implement primarily disposed within the elongated body, the writing implement having an electric charge substantially at the tip for writing on the substrate which is responsive to an applied electric field.

According to a further feature of the present invention, the locator device includes at least one ultrasound transducer deployed adjacent to the tip.

According to a further feature of the present invention, the writing implement includes an electrically charged member which is at least partially insulated.

According to a further feature of the present invention, there is also provided a pressure release arrangement disposed between the writing implement and the elongated body, the pressure release arrangement being configured to prevent localized pressure of the writing implement from destroying the substrate.

According to a further feature of the present invention, there is also provided a digitizer pen system comprising: (a) the digitizer pen; and (b) at least one sheet of electronic paper responsive to proximity of the writing implement to generate a localized visible change of appearance.

A digitizer pen comprising a pen having: (a) an elongated body terminating in a tip; (b) a locator device configured to enable tracking a location of the tip on a substrate; and (c) a writing implement primarily disposed within the elongated body, the writing implement being configured to produce an electric charge substantially at the tip for writing on the substrate which is responsive to an applied electric field.

According to a further feature of the present invention, the locator device includes at least one ultrasound transducer deployed adjacent to the tip.

According to a further feature of the present invention, there is also provided a pressure release arrangement disposed between the writing implement and the elongated body, the pressure release arrangement being configured to prevent localized pressure of the writing implement from destroying the substrate.

According to a further feature of the present invention, the pen includes an electric cell having two electrical contacts, the writing implement includes a chargeable member configured for electrical connection with one of the electrical contacts in order to electrically charge the chargeable member and the chargeable member is at least partially insulated.

According to a further feature of the present invention, the pen includes a polarity controller configured to electrically connect the chargeable member with another of the electrical contacts instead of the one electrical contact in order to enable the writing implement to produce an electric charge substantially at the tip for performing an erasing function on the substrate.

According to a further feature of the present invention, the pen includes a grounding controller configured to ground the chargeable member in order to enable the writing implement to perform a pointing device function.

According to a further feature of the present invention, the elongated body includes an electrically conducting portion configured to enable electrical connection of another of the electrical contacts with the substrate.

According to a further feature of the present invention, the pen includes a contact switch disposed within the elongated body, the contact switch being configured to enable electrical connection between the electrical cell and the chargeable member when the writing implement is in contact with the substrate.

According to a further feature of the present invention, there is also provided a digitizer pen system comprising: (a) the digitizer pen; and (b) at least one sheet of electronic paper responsive to proximity of the writing implement to generate a localized visible change of appearance.

A digitizer pen comprising a pen having: (a) an elongated body terminating in a tip; (b) a locator device configured to enable tracking a location of the tip on a substrate; and (c) a writing implement primarily disposed within the elongated body, the writing implement having a magnetic arrangement being configured to produce a concentration of magnetic field lines near the tip for writing on the substrate which is responsive to an applied magnetic field.

According to a further feature of the present invention, the locator device includes at least one ultrasound transducer deployed adjacent to the tip.

According to a further feature of the present invention, there is also provided a pressure release arrangement disposed between the writing implement and the elongated body, the pressure release arrangement being configured to prevent localized pressure of the writing implement from destroying the substrate.

According to a further feature of the present invention, there is also provided a digitizer pen system comprising: (a) the digitizer pen; and (b) at least one sheet of magnetic paper responsive to proximity of the writing implement to generate a localized visible change of appearance.

According to a further feature of the present invention, the magnetic arrangement includes a permanent magnet located close to the tip.

According to a further feature of the present invention, the magnetic arrangement includes a permanent magnet and a soft magnetic element associated with the permanent magnet, the soft magnetic element being disposed close to the tip.

According to a further feature of the present invention, the magnetic arrangement includes an electromagnet and a soft magnetic element associated with the electromagnet, said soft magnetic element being disposed close to said tip.

### BRIEF DESCRIPTION OF THE DRAWINGS

The invention is herein described, by way of example only, with reference to the accompanying drawings, wherein:

FIG. 1 is a schematic view of a digitizer pen configured for writing on magnetic paper that is constructed and operative in accordance with a preferred embodiment of the invention;

FIG. 2 is a schematic view of a digitizer pen configured for writing on magnetic paper that is constructed and operative in accordance with a first alternate embodiment of the invention;

FIG. 3 is a schematic view of a digitizer pen configured for writing on electronic paper that is constructed and operative in accordance with a second alternate embodiment of the invention; and

FIG. 4 is a schematic view of a digitizer pen configured for writing on electronic paper that is constructed and operative in accordance with a third alternate embodiment of the invention.

### DESCRIPTION OF THE PREFERRED EMBODIMENTS

The present invention is a digitizer pen configured for temporary writing.

The principles and operation of a digitizer pen according to the present invention may be better understood with reference to the drawings and the accompanying description.

By way of introduction, there is a short-term need to see the writing of digitizer pen on the paper being used, as writing or drawing a picture is difficult if no visible impression is left of previous pen strokes. However, long term written record is made redundant. Therefore, this problem can be solved by using a paper that is responsive to a magnetic or electric field close to the writing tip of the pen. Magnetic paper is taught by U.S. Pat. No. 3,036,388 to Tate and U.S. Pat. No. 5,411,398 to Nakanishi, et al.

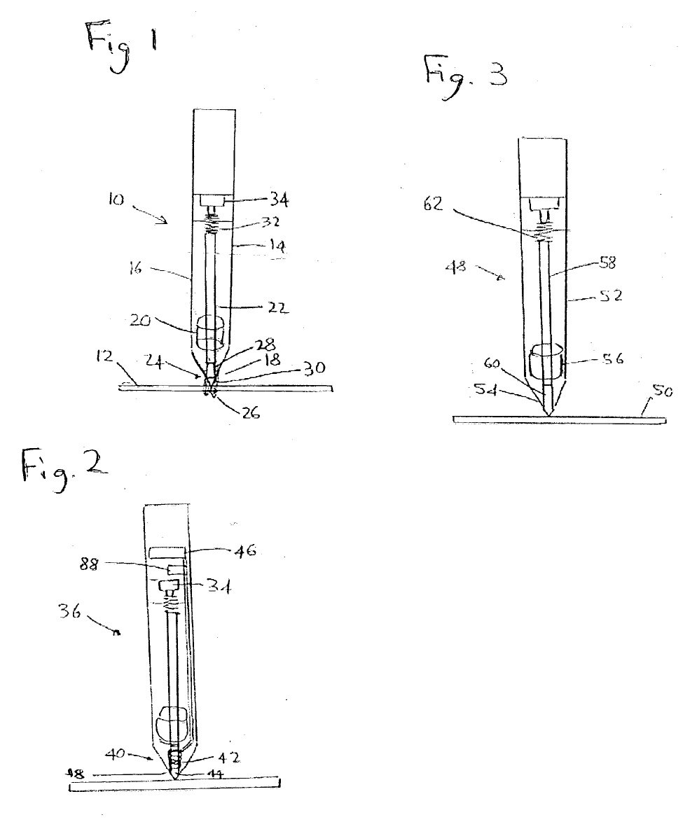

FIG. 1 is a schematic view of a digitizer pen 10 configured for writing on a sheet of magnetic paper 12 that is constructed and operative in accordance with a preferred embodiment of the invention. Magnetic paper 12 is a substrate, which is responsive to proximity of an applied magnetic field to generate a reversible localized visible change of appearance in the substrate. Digitizer pen 10 has an elongated body 14 that has a main grip surface 16. Elongated body 14 terminates in a tip 18. Digitizer pen 10 includes a locator device configured to enable tracking a location of tip 18 on magnetic paper 12. The locator device typically includes at least one ultrasound transducer 20 deployed adjacent to tip 18 below the surface of elongated body 14. Digitizer pen 10 also includes a writing implement 22 primarily disposed within elongated body 14. The main body of writing implement 22 is typically formed from plastic or metal. Writing implement 22 also includes a magnetic arrangement 24 being configured to produce a concentration of magnetic field lines 26 near to tip 18 for writing on magnetic paper 12. If the magnetic field is not concentrated near to tip 18, then the magnetic field will not create a clear image on magnetic paper 12 but a blurred image. The concentration of the magnetic field lines 26 around tip 18 is to ensure that magnetic arrangement 24 produces a localized visible change of appearance on magnetic paper 12, creating a clear image and not a blurred image of the moving tip 18 of digitizer pen 10. Magnetic arrangement 24 includes a permanent magnet 28, typically a bar magnet, located close to tip 18. Permanent magnet 28 has its direction of elongation parallel to the direction of elongation of elongated body 14. Magnetic arrangement 24 also includes a soft magnetic element 30, which is associated with permanent magnet 28. Soft magnetic element 30 is typically a soft iron conical shell. Soft magnetic element 30 is configured to restrict the magnetic field produced by permanent magnet 28 such that, the magnetic field produced by permanent magnet 28 extends beyond tip 18 in a direction parallel with the direction of elongation of elongated body 14. However, the strength of the magnetic field in a direction perpendicular to the direction of elongation of elongated body 14 attenuates rapidly. Digitizer pen 10 also includes a pressure release arrangement 32. Pressure release arrangement 32, typically a spring, is disposed between writing implement 22 and elongated body 14. Pressure release arrangement 32 is configured to prevent localized pressure of writing implement 22 from destroying magnetic paper 12. Digitizer pen 10 typically includes a contact switch 34. Contact switch 34 is disposed such that, when writing implement 22 is in contact with magnetic paper 12, contact switch 34 is activated. When contact switch 34 is activated, the digitizer system knows that a writing action is being performed and movements of digitizer pen 10 are interpreted as writing movements. The restoring force of pressure release arrangement 32 is greater than the restoring force of contact switch 34.

FIG. 2 is a schematic view of a digitizer pen 36 configured for writing on a sheet of magnetic paper 38 that is constructed and operative in accordance with a first alternate embodiment of the invention. Digitizer pen 36 is substantially the same as digitizer pen 10 (FIG. 1) except that magnetic arrangement 24 (FIG. 1) is replaced by an electromagnetic arrangement 40 which includes an electromagnet 42 which is disposed close to a soft magnetic element 44. Soft magnetic element 44 is typically a soft iron rod terminating in a conical tip. The conical tip of soft magnetic element 44 is disposed close to tip 18. Electromagnet 42 is powered by an electric cell 46. A step-up voltage converter 88 is included which increases the voltage supplied to electromagnet 42 by electric cell 46. Electromagnet 42 is activated by contact switch 34. Contact switch 34 also provides the functionality described with reference to FIG. 1.

By way of introduction, electronic paper is available that is responsive to an applied electric field. As an applied electric field is brought close to the electronic paper the surface of the paper changes color. Electronic paper is commercially available from E-Ink, Cambridge, Mass. E-Ink's electronic paper contains millions of spherical transparent spheres, each one approximately 100 microns in diameter. Each sphere is filled with a densely colored liquid and white titanium dioxide particles. Electrodes are printed on the bottom of the electronic paper. When a positive electric field is applied above the spheres, the white titanium dioxide particles move to the top of the spheres making the surface of the electronic paper appear white. Electronic paper is also commercially available from Xerox and 3M, who produce electronic paper called Gyricon. Gyricon is a thin layer of transparent plastic in which millions of small beads, somewhat like toner particles, are randomly dispersed. The beads, each contained in an oil-filled cavity, are free to rotate within those cavities. The beads are bichromal i.e.: having hemispheres of two contrasting colors and charged so they exhibit an electrical dipole. When an electric field is applied to the surface of the sheet, the beads rotate to present one colored side to the viewer. The image will persist until new electric field patterns are applied.

FIG. 3 is a schematic view of a digitizer pen 48 configured for writing on a sheet of electronic paper 50 that is constructed and operative in accordance with a second alternate embodiment of the invention. Digitizer pen 48 has an elongated body 52 terminating in a tip 54. Digitizer pen 48 also includes a locator device configured to enable tracking a location of tip 54 on electronic paper 50. The locator device of digitizer pen 48 typically includes at least one ultrasound transducer 56 deployed adjacent to tip 54. Digitizer pen 48 also includes a writing implement 58 primarily disposed within elongated body 52. Writing implement 58 includes an electrically charged member 60. Therefore, there is an electric charge substantially at tip 54 for writing on electronic paper 50 or any substrate responsive to an applied electric field. The electric charge is described as being “substantially at tip 54” in that the electric field produced by electrically charged member 60 extends beyond tip 54 in a direction parallel with the direction of elongation of elongated body 52. However, the strength of the electric field in a direction perpendicular to the direction of elongation of elongated body 52 attenuates rapidly. Electronic paper 50 is therefore responsive to proximity of writing implement 58 to generate a localized visible change of appearance on the surface of electronic paper 50. It should be noted that electronic paper 50 generally needs to be grounded at the bottom surface thereof, in order for writing implement 58 to generate a localized visible change of appearance on the surface of electronic paper 50. Electrically charged member 60 is insulated to prevent unnecessary loss of electric charge especially when electrically charged member 60 is handled during inserting of a new electrically charged member into elongated body 52. Electrically charged member 60 is configured to be replaceable with writing implement 58. The removal of writing implement 58 is problematic, as digitizer pen 48 cannot be dismantled like conventional pens due to internal electronics. Therefore, writing implement 58 needs to be inserted into elongated body 52 via the opening in elongated body 52 at tip 54. A system for retaining writing implement 58 within and removing writing implement 58 from elongated body 52 is described in co-pending U.S. application Ser. No. 10/098,390 filed Mar. 18^{th}, 2002. As with digitizer pen 10 (FIG. 1), digitizer pen 48 includes a pressure release arrangement 62 to prevent writing implement 58 destroying electronic paper 50.

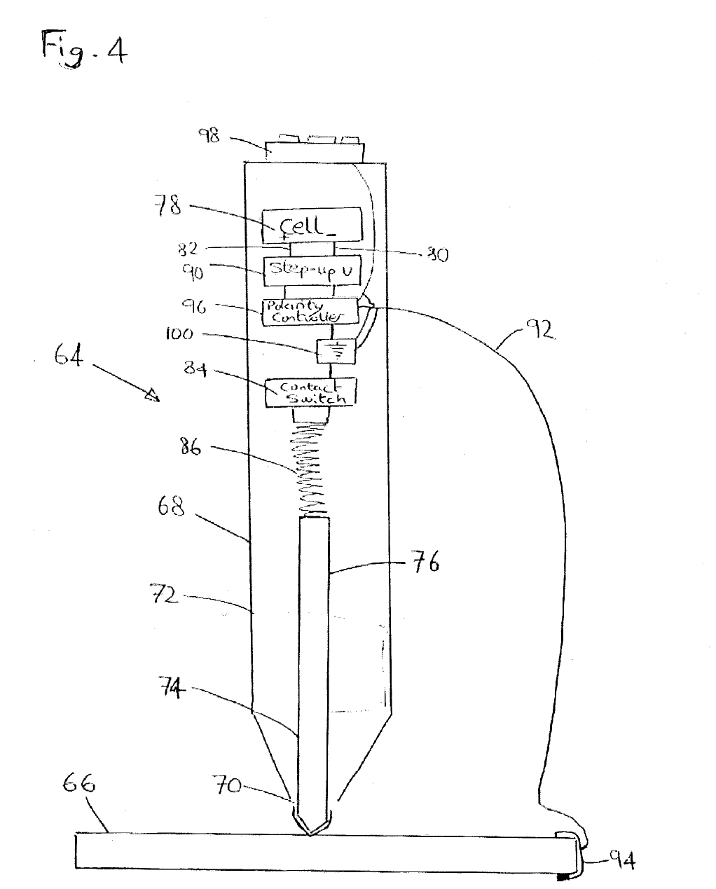

FIG. 4 is a schematic view of a digitizer pen 64 configured for writing on a sheet of electronic paper 66 that is constructed and operative in accordance with a third alternate embodiment of the invention. Digitizer pen 64 is substantially the same as digitizer pen 48 (FIG. 3). However, digitizer pen 64 only produces an electric field when the writing implement is in contact with the writing substrate. Digitizer pen 64 has an elongated body 68 terminating in a tip 70. Digitizer pen 64 also includes a locator device configured to enable tracking a location of tip 70 on electronic paper 66. The locator device of digitizer pen 64 typically includes also includes at least one ultrasound transducer 72 deployed adjacent to tip 70. Digitizer pen 64 also includes a writing implement 74 primarily disposed within elongated body 68. Writing implement 74 is configured to produce an electric charge substantially at tip 70 for writing on electronic paper 66 or any substrate responsive to an applied electric field. Therefore, electronic paper 66 is responsive to proximity of writing implement 74 to generate a localized visible change of appearance on the surface of electronic paper 66. Writing implement 74 includes a chargeable member 76, typically formed from copper. Digitizer pen 64 includes an electric cell 78 having two electrical contact 80, 82. Digitizer pen 64 also includes a step-up voltage converter 90. In order for digitizer pen 64 to cause a localized visible change of appearance on electronic paper 66, electrical contact 80 needs to be connected to the lower surface of electronic paper 66. In accordance with a preferred embodiment of the present invention, digitizer pen 64 includes a wire 92 having one end connected to electrical contact 80 and another end connected to the lower surface of electronic paper 66. Wire 92 is typically connected to electronic paper 66 using a conducting chip 94. In accordance with a first alternate embodiment of the present invention, elongated body 68 is formed from a conducting material, such as a conducting metal. Electrical contact 80 is electrically connected to elongated body 68. The user of digitizer pen 64 holds the conducting surface of elongated body 68 and the user also touches the lower surface of electronic paper 66, thereby causing a connection between electrical contact 80 and the lower surface of electronic paper 66. In accordance with a second alternate embodiment of the present invention, elongated body 68 is formed from a conducting material, such as a conducting metal. Electrical contact 80 is electrically connected to elongated body 68. The user of digitizer pen 64 holds the conducting surface of elongated body 68, thereby grounding electrical contact 80. The lower surface of electronic paper 66 is also grounded.

Electrical contact 82 is connected to chargeable member 76 via a contact switch 84 and via step-up voltage converter 90. Step-up voltage converter 90 increases the voltage supplied by electric cell 78 to chargeable member 76. Contact switch 84 is configured such that, when writing implement 74 is in contact with electronic paper 66, contact switch 84 is activated enabling electrical connection between electrical contact 82 and chargeable member 76 so that chargeable member 76 is thereby charged. Contact switch 84 also enables the digitizer system to know when to record writing movements, as explained above with reference to FIG. 1. Chargeable member 76 is also at least partially insulated to prevent unnecessary loss of electric charge. Digitizer pen 64 also includes a pressure release arrangement 86, substantially the same as pressure release arrangement 32 (FIG. 1).

Digitizer pen 64 includes a polarity controller 96, which is typically operated by an user operated switch 98 which is disposed on the exterior surface of elongated body 68. Polarity controller 96 is configured to electrically connect chargeable member 76 with electrical contact 80 instead of electrical contact 82, thereby reversing the polarity of chargeable member 76, in order to enable writing implement 74 to produce an electric charge substantially at tip 70 for performing an erasing function on electronic paper 66. It will be appreciated by one ordinarily skilled in the art that digitizer pen 36 which operates using electromagnet 42 can also be configured to perform an erasing function on magnetic paper 12 by reversing the polarity of the contacts of electromagnet 42.

Digitizer pen 64 also includes a grounding controller 100, which is operated by switch 98. Grounding controller 100 is configured to ground chargeable member 76 in order to enable writing implement 74 to perform a pointing device function, for example, as performed by a mouse without generating a localized visible change of appearance on the surface of electronic paper 66 even when contact switch 84 is activated. In accordance with the preferred embodiment of the present invention chargeable member 76 is grounded via wire 92. In accordance with the first and second alternate embodiments of the present invention, chargeable member 76 is grounded via the user who is holding the electrically conducting surface of elongated body 68. It will be apparent to one ordinarily skilled in the art that digitizer pen 64 can include an additional switch to perform the functions of the standard mouse “click” buttons.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art which would occur to persons skilled in the art upon reading the foregoing description.

What is claimed is:

1. A digitizer pen comprising a pen having:
(a) an elongated body terminating in a tip;
(b) a locator device configured to enable tracking a location of said tip on a substrate; and
(c) a writing implement primarily disposed within said elongated body, said writing implement having an electric charge substantially at said tip for writing on said substrate which is responsive to an applied electric field.

2. The digitizer pen of claim 1, wherein said locator device includes at least one ultrasound transducer deployed adjacent to said tip.

3. The digitizer pen of claim 1, wherein said writing implement includes an electrically charged member which is at least partially insulated.

4. The digitizer pen of claim 1, further comprising a pressure release arrangement disposed between said writing implement and said elongated body, said pressure release arrangement being configured to prevent localized pressure of the writing implement from destroying said substrate.

5. A digitizer pen system comprising:
(a) the digitizer pen of claim 1; and
(b) at least one sheet of electronic paper responsive to proximity of said writing implement to generate a localized visible change of appearance.

6. A digitizer pen comprising a pen having:
(a) an elongated body terminating in a tip;
(b) a locator device configured to enable tracking a location of said tip on a substrate; and
(c) a writing implement primarily disposed within said elongated body, said writing implement being configured to produce an electric charge substantially at said tip for writing on said substrate which is responsive to an applied electric field.

7. The digitizer pen of claim 6, wherein said locator device includes at least one ultrasound transducer deployed adjacent to said tip.

8. The digitizer pen of claim 6, further comprising a pressure release arrangement disposed between said writing implement and said elongated body, said pressure release arrangement being configured to prevent localized pressure of the writing implement from destroying said substrate.

9. The digitizer pen of claim 6, wherein:
(a) said pen includes an electric cell having two electrical contacts;
(b) said writing implement includes a chargeable member configured for electrical connection with one of said electrical contacts in order to electrically charge said chargeable member; and
(c) said chargeable member is at least partially insulated.

10. The digitizer pen of claim 9, wherein said pen includes a polarity controller configured to electrically connect said chargeable member with another of said electrical contacts instead of said one electrical contact in order to enable said writing implement to produce an electric charge substantially at said tip for performing an erasing function on said substrate.

11. The digitizer pen of claim 9, wherein said pen includes a grounding controller configured to ground said chargeable member in order to enable said writing implement to perform a pointing device function.

12. The digitizer pen of claim 9, wherein said elongated body includes an electrically conducting portion configured to enable electrical connection of another of said electrical contacts with said substrate.

13. The digitizer pen of claim 9, wherein said pen includes a contact switch disposed within said elongated body, said contact switch being configured to enable electrical connection between said electrical cell and said chargeable member when said writing implement is in contact with said substrate.

14. A digitizer pen system comprising:
(a) the digitizer pen of claim 6; and
(b) at least one sheet of electronic paper responsive to proximity of said writing implement to generate a localized visible change of appearance.

15. A digitizer pen comprising a pen having:
(a) an elongated body terminating in a tip;
(b) a locator device configured to enable tracking a location of said tip on a substrate; and
(c) a writing implement primarily disposed within said elongated body, said writing implement having a magnetic arrangement being configured to produce a concentration of magnetic field lines near said tip for writing on said substrate which is responsive to an applied magnetic field.

16. The digitizer pen of claim 15, wherein said locator device includes at least one ultrasound transducer deployed adjacent to said tip.

17. The digitizer pen of claim 15, further comprising a pressure release arrangement disposed between said writing implement and said elongated body, said pressure release arrangement being configured to prevent localized pressure of the writing implement from destroying said substrate.

18. A digitizer pen system comprising:
(a) the digitizer pen of claim 15; and
(b) at least one sheet of magnetic paper responsive to proximity of said writing implement to generate a localized visible change of appearance.

19. The digitizer pen of claim 15, wherein said magnetic arrangement includes a permanent magnet located close to said tip.

20. The digitizer pen of claim 15, wherein said magnetic arrangement includes a permanent magnet and a soft magnetic element associated with said permanent magnet, said soft magnetic element being disposed close to said tip.

21. The digitizer pen of claim 15, wherein said magnetic arrangement includes an electromagnet and a soft magnetic element associated with said electromagnet, said soft magnetic element being disposed close to said tip.
